(19) United States
(12) Patent Application Publication
(10) Pub. No.: US 2009/0302673 A1
(43) Pub. Date: Dec. 10, 2009

(54) METHOD FOR OPERATING A COMBINED VEHICLE BRAKING SYSTEM

(75) Inventor: Paul Linhoff, Neu-Anspach (DE)

Correspondence Address: RATNERPRESTIA, P.O. BOX 980, VALLEY FORGE, PA, 19482, US

(73) Assignee: Continental Teves AG & Co. oHG, Frankfurt (DE)

(21) Appl. No.: 12/306,754

(22) PCT Filed: Jun. 26, 2007
(86) PCT No.: PCT/EP07/56355

§ 371 Date: Dec. 29, 2008

(51) Int. Cl. B60T 13/74

(52) U.S. Cl. 303/3

(57) ABSTRACT

A method for operating a combined vehicle braking system comprising hydraulically actuable wheel brakes on a front axle of a motor vehicle and electromechanically actuable wheel brakes on a rear axle of the motor vehicle is described. The method comprises the steps of (a) driving the wheels of the rear axle by an electric motor which is configured to be operated as a generator in order to recover braking energy at the rear axle; (b) detecting a driver's braking request; (c) communicating the driver's braking request to a control unit which is configured to implement a braking force distribution for the electric motor and the wheel brakes on the front axle and the rear axle; and (d) implementing the braking force distribution in the range of low vehicle deceleration such that a proportion of extracted braking force at the rear axle is greater than that of the front axle.

### CROSS REFERENCE TO RELATED APPLICATIONS

This application is the U.S. national phase application of PCT International Application No. PCT/EP2007/056355, filed Jun. 26, 2007, which claims priority to German Patent Application No. DE 102006030927.8, filed Jul. 3, 2006 and German Patent Application No. DE 102006055765.4, filed Nov. 25, 2006, the contents of such applications being incorporated by reference herein.

### BACKGROUND OF THE INVENTION

1. Field of the Invention

The invention relates to a method for operating a combined vehicle braking system, in particular for motor vehicles.

2. Description of the Related Art

A combined vehicle braking system for motor vehicles is disclosed. The combined vehicle braking system generally comprises hydraulically actuable wheel brakes on a front axle and electromechanically actuable wheel brakes on a rear axle, wherein the vehicle wheels which are assigned to one axle or to both axles are driven at least intermittently by an electric motor which can be operated as a generator in order to recover braking energy, and in the generator mode a braking force is brought about at the vehicle wheels which are assigned to the drive axle, and wherein a pedal travel sensor determines the driver's braking request and feeds it to an open-loop and closed-loop control unit which carries out a braking force distribution for the hydraulically actuable wheel brakes, the electromechanically actuable wheel brakes and the electric motor which can be operated in the generator mode.

The purpose of such brake systems in motor vehicles is to recover as much of the energy converted during braking, to store it in the vehicle and to re-use it to drive the vehicle. As a result, the consumption of energy by the vehicle overall can be lowered, the efficiency can be increased and the operation can therefore be made more economical. Motor vehicles having a brake system which is configured for regenerative braking generally have for this purpose various types of brakes which are also referred to as brake actuators.

In this context, a pair of hydraulic friction brakes are used for braking the front axle wheels, and a pair of electromechanically actuable friction brakes are used for braking the rear axle wheels, as are known from conventional motor vehicles, along with an electric motor which can be operated as a generator. As much of the entire braking force as possible is harnessed by means of the generator or the electric motor which is in the generator mode. The acquired electrical energy is fed into or fed back into a storage medium such as, for example, an on-board battery, and is re-used to drive the motor vehicle by means of a suitable drive.

In order to brake such a motor vehicle which has an electric motor as a sole drive or additional drive and for recovering braking energy in the generator mode, a further braking torque is applied by the electric motor in addition to the braking torque of the hydraulically actuable and/or electromechanically actuable wheel brakes, which latter braking torque is applied by the driver-actuated brake system. This braking torque of the electric motor arises from the known effect in electric motors which, when they are driven mechanically without electric current being supplied, act as a dynamo or generator and generate electric current. In this context, an opposing torque, which counteracts the mechanical drive and acts in the present case as a braking torque, is produced. The electric motor which is operated as a generator therefore acts as a brake. The entire braking force of the motor vehicle is composed here of the braking force of the hydraulically actuable wheel brakes, the braking force of the electromechanically actuable wheel brakes and the braking force of the electric motor which acts as a generator.

DE 103 19 663 A1 discloses a method for setting the pedal characteristic curve of a hybrid brake system with a changed braking force distribution. In the previously known method for operating a braking system, which method comprises a hydraulic operating brake system and an electric operating brake system with wheel brakes to which brake pressure is applied when a brake pedal is actuated, the control unit controls a brake pressure modulator of the hydraulic operating brake system and the electric operating brake system in such a way that when there is a change in the braking force distribution between the hydraulic and the electric operating brake systems the ratio of the pedal force and/or pedal travel to the overall braking torque of the vehicle remains essentially constant. An electric motor which can be operated as a generator is not provided.

The potential for recovering braking energy is, for a combined vehicle braking system of the generic type specified at the beginning and given a braking force distribution from the front axle to the rear axle of 50% to 50%, correspondingly 50%. However, for the lower deceleration range, a large increase in the proportion of braking force is considered possible and permissible at the rear axle relative to the front axle.

An object of the present invention is therefore to present a method which contributes to improving the energy recovery potential.

### SUMMARY OF THE INVENTION

This object is achieved in that the braking force distribution is carried out in the range of low vehicle decelerations in such a way that the proportion of braking force at the vehicle wheels of the rear axle is greater than the proportion of braking force at the vehicle wheels of the front axle. In this context there is additionally provision that the proportion of braking force at the vehicle wheels of the driven axle, preferably mainly the rear axle, is generated exclusively, or virtually exclusively, by the electric motor which is in the generator mode.

In order to make the method more specific there is provision that the braking force at the hydraulic wheel brakes is between 0% and 49% of the braking force for the entire motor vehicle, while the braking force which is generated by the electric motor which is in the generator mode is between 51% and 100% of the braking force for the entire motor vehicle.

In contrast, it is provided that the braking force distribution is carried out in the range of relatively high vehicle decelerations in such a way that the proportion of braking force at the vehicle wheels of the rear axle is the same as, virtually the same as or smaller than the proportion of braking force at the vehicle wheels of the front axle.

The range of low vehicle decelerations is below a vehicle deceleration of 0.3 g, while the range of relatively high vehicle decelerations is above a vehicle deceleration of 0.3 g.

In one particularly advantageous development of the method there is provision that the pedal travel sensor determines the actuation travel of a brake pedal, and the electric motor is driven in the generator mode directly after a driver's braking request has been detected. In this context, there is, in particular, provision that the driving of the electric motor in the generator mode is carried out before the hydraulically actuable wheel brakes make available a braking force. As a result of this measure, when a driver's braking request is detected, braking energy is immediately recovered before all the free travel in the hydraulic brake system is traveled through. The device here has the effect of optimizing the free travel.

These and other aspects of the invention are illustrated in detail by way of the embodiments and are described with respect to the embodiments in the following, making reference to the Figures.

### BRIEF DESCRIPTION OF THE DRAWINGS

The invention will be explained in more detail below by means of an exemplary embodiment with reference to the appended drawing, in which:

FIG. 1 shows a schematically illustrated circuit diagram of a combined vehicle braking system comprising hydraulically actuable wheel brakes on the front axle, electromechanically actuable wheel brakes on the rear axle and an electric motor for regenerative braking;

FIG. 2 shows a braking force distribution, previously known from the prior art, between the front axle and rear axle in a conventional brake system;

FIG. 3 shows a braking force distribution which is previously known from the prior art, such as is provided in a combined vehicle braking system of the generic type illustrated in FIG. 1;

FIG. 4 shows a braking force distribution according to the inventive method with regenerative braking, and

FIG. 5 shows a diagram of the tensioning force profiles plotted against the deceleration of the vehicle.

### DETAILED DESCRIPTION OF THE PREFERRED EMBODIMENTS

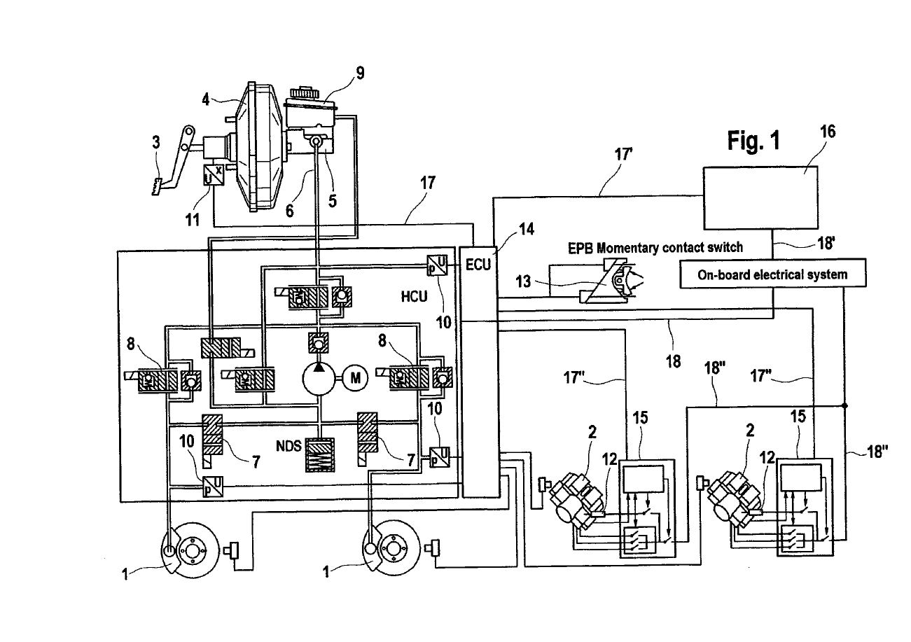

A circuit diagram of the vehicle braking system according to aspects of the invention is illustrated in FIG. 1. The vehicle braking system according to aspects of the invention has, on the one hand, hydraulically actuable wheel brakes 1 and, on the other hand, electromechanically actuable wheel brakes 2. The hydraulically actuable wheel brakes 1 are arranged on a first axle of the motor vehicle, the front axle, and hydraulic pressure medium is applied to them using a pedal-actuated vacuum brake booster 4 with master cylinder 5 connected downstream. For this purpose, the hydraulically actuable wheel brakes 1 are connected to the master cylinder 5 with the intermediate connection of inlet valves 8 via a hydraulic line 6. In order to determine the applied hydraulic pressure and to carry out control processes, such as for example anti-lock control operations, a plurality of pressure sensors 10 are provided whose output signals are fed to a central open-loop and closed-loop control unit 14. Furthermore, an embodiment is possible in which the two pressure sensors at the wheels are dispensed with, but a further pressure sensor is provided in the floating piston circuit which determines the pressure on the THz side.

As is also apparent from FIG. 1, electromechanically actuable wheel brakes 2, which can be actuated in accordance with the hydraulic pressure applied in the hydraulically actuable wheel brakes 1 are arranged on a second axle, the rear axle of the motor vehicle. As already mentioned, the pressure which is applied to the hydraulically actuable wheel brakes 1 is determined using the pressure sensors 10. On the basis of this pressure value, the electromechanically actuable wheel brakes 2 on the rear axle are actuated, i.e. an application force of the electromechanically actuable wheel brakes 2 is set taking into account a braking force distribution function between the front axle and rear axle. Furthermore, the electromechanically actuable wheel brakes 2 are actuated in accordance with the actuation travel of the brake pedal 3, that is to say in accordance with the vehicle driver's request. For this purpose, the actuation travel of the brake pedal 3 is determined using a pedal travel sensor 11. The travel can also be determined by measuring angles or by measuring linear movements in the amplifier unit (diaphragm travel sensor). The electromechanically actuable wheel brakes 2 are actuated in a decentralized fashion by means of two electronic control units 15 which are each assigned to an electromechanically actuable wheel brake 2. Electrical energy is supplied via a supply line 18″ which connects the electromechanically actuable wheel brakes 2 to the vehicle's on-board electrical system.

As is indicated merely schematically in FIG. 1, the electromechanically actuable wheel brakes 2 have a foundation braking device 12 with which the wheel brakes for carrying out foundation braking in the applied state can be locked. The foundation braking device 12 can be actuated using an operator control element 13. The operator control element 13 is embodied as a momentary contact switch and has three switched positions for the instructions “apply”, “neutral” and “release”, with only the central neutral position constituting a stable switched position.

The driver's braking request is, as already mentioned, sensed by the pedal travel sensor 11 and fed via a signal line 17 to the electronic open-loop and closed-loop control unit 14. The signals of the operator control element 13 of the foundation brake are fed to the open-loop and closed-loop control unit 14. The two decentralized electronic open-loop control units 15 of the electromechanically actuable wheel brakes 2 are also connected to the open-loop and closed-loop control unit 14 via a signal line 17″.

An electric motor 16 which, on the one hand, acts as an independent drive in an electric car or as an additional drive in a vehicle with an internal combustion engine and, on the other hand, is set to recover braking energy in the generator mode, is connected to the open-loop and closed-loop control unit 14 via a further signal line 17′. The electric motor 16 draws its supply voltage in the case of driving via a supply line 18′ from the vehicle's on-board electrical system and feeds electrical energy back into the vehicle's on-board electrical system via the same supply line 18′ in the generator mode. In the generator mode just mentioned, the electric motor 16 acts as a dynamo and generates electric current. In the process an opposing force is produced which acts a further braking torque. The electric motor 16 which is operated as a generator therefore acts as a brake. The entire braking force of the motor vehicle is therefore composed of the braking force of the hydraulically actuable wheel brakes 1, the braking force of the electromechanically actuable wheel brakes 2 and the braking force of the electric motor 16 which acts as a generator. These three braking forces have to be adapted in a suitable way, which is made possible by a suitable braking force distribution, in which case a largely constant relationship exists between the driver's specification through the pedal travel and reaction force of the brake pedal and the front axle brake pressure. Furthermore, a corresponding relationship is assigned to the pedal travel and to the front axle brake pressure according to a fixed algorithm or according to a reproducible algorithm. The rear axle braking force of the electromechanical brakes can then, however, be set freely from zero to a maximum value without a reaction on the brake pedal. As a result, the braking forces from the generator and the rear axle friction brake can be balanced with the same deceleration of the vehicle and without a reaction on the brake pedal.

In the instances of braking force distribution which follow, the braking force at the rear axle, referred to also as RA for short, is always plotted on the ordinate, and the braking force at the front axle, also referred to as FA for short, is always plotted on the abscissa.

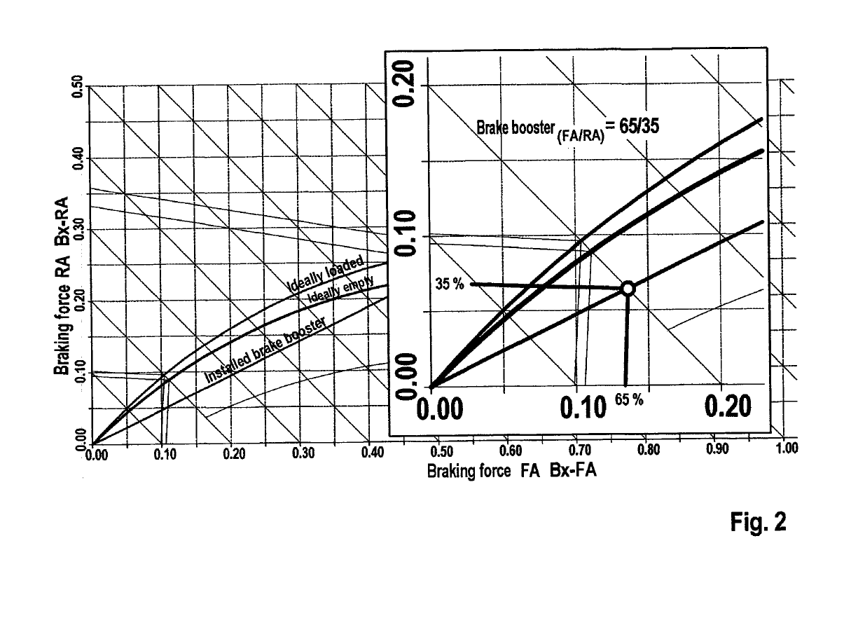

In order to bring about a suitable braking force distribution for the three abovementioned braking forces, the previously known braking force distribution of a conventional braking system will first be considered on the basis of FIG. 2, that is to say a braking system with exclusively hydraulically actuable wheel brakes which are actuated by a vacuum brake booster. In such a hydraulic braking system, the braking force distribution provides for 65% of the braking force for the entire vehicle to be applied by the wheel brakes of the front axle, while the remaining 35% of the entire braking force is applied by the wheel brakes of the rear axle.

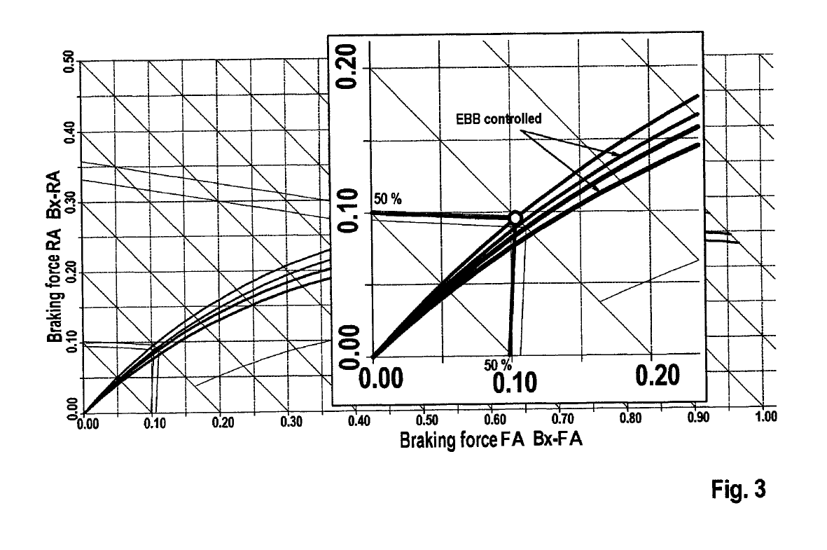

FIG. 3 shows a braking force distribution previously known from the prior art, as is provided in a combined vehicle braking system which is described with reference to FIG. 1, with hydraulically actuable wheel brakes 1 on the front axle and electromechanically actuable wheel brakes 2 on the rear axle. The braking force distribution provides what is referred to as 50/50 division, i.e. that 50% of the braking force for the entire vehicle is applied by the hydraulically actuable wheel brakes 1 of the front axle and 50% of the entire braking force is applied by the electromechanical wheel brakes 2 of the rear axle. In regeneration mode the electromechanically actuable wheel brakes 2 do not, however, make available a braking force, or only make available a relatively small braking force, and the missing proportion of the braking force is generated by the electric motor 16 which is operated as a generator. Therefore, the potential for recovery of the braking energy given the abovementioned braking force distribution of the static vehicle weight of 50%/50% is correspondingly 50% of the braking energy.

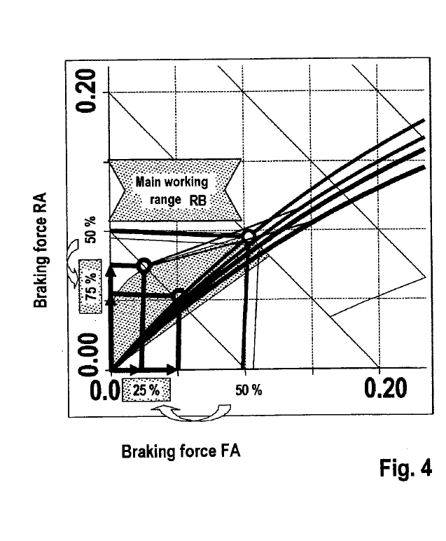

The present invention then provides for the potential for the recovery of braking energy to be increased on the basis of the braking force distribution described in FIG. 3. As is illustrated in FIG. 4, for this purpose the braking force distribution is changed in the range of low vehicle decelerations in such a way that the proportion of braking force at the vehicle wheels of the rear axle is greater than the proportion of the braking force at the vehicle wheels of the front axle. Since, as already described, the braking force at the vehicle wheels of the rear axle can be generated exclusively by means of the generator in the regeneration mode, that is to say since the proportion of braking force at the vehicle wheels of the rear axle can be generated exclusively or virtually exclusively by means of the electric motor 16 which is in the generator mode, the braking energy which is recovered increases significantly. For the lower deceleration range, it is considered possible and permissible to implement a large increase in the proportion of braking force at the rear axle relative to the front axle. A typical driving cycle of a vehicle in the regeneration mode does not contain any decelerations which are above said main working range of the regenerative braking, which is referred to as “main working range RB” in FIG. 4. (Owing to the limited power of the generator and of the power drain of the electrical accumulator, possible deceleration is limited to said range). In the exemplary embodiment illustrated in FIG. 4, the braking force at the front axle is reduced from 50% to 25%, while the braking force at the rear axle is increased from 50% to 75%. However, there is generally provision that the braking force at the hydraulic wheel brakes 1 at the front axle is between 0% and 49% of the braking force for the entire motor vehicle, while the braking force at the rear axle which is generated by the electric motor 16 which is in the generator mode is between 51% and 100% of the entire braking force.

As is also apparent from FIG. 4, the braking force distribution in the case of relatively high vehicle decelerations returns to the ideal braking force distribution. That is to say in the region of relatively high vehicle decelerations the proportion of braking force of the front axle with respect to the rear axle is of the same magnitude, with the result that it corresponds to a 50%/50% division, or the proportion of braking force at the rear axle is smaller than the proportion of braking force at the front axle, with the result that it corresponds to a 70%/30% division or a 65%/35% division. The value of 0.3 g is appropriate for the dividing line between the range of relatively low deceleration and that of relatively high deceleration. Depending on the situation, this value can, however, also be smaller, and in an extreme case it can even be only 0.15 g. However, these values are only exemplary and depend very greatly on the power of the generator with respect to the weight of the vehicle, on the geometry of the chassis and on further vehicle-specific parameters.

As already described, the pedal travel sensor 11 determines the actuation travel of the brake pedal 3 and detects the driver's request. In this context, it is particularly advantageous that the electric motor 16 in the generator mode is actuated directly after detection of a driver's braking request, as is apparent in FIG. 4. In this context, the actuation of the electric motor 16 is carried out in the generator mode before the hydraulically actuable wheel brakes 1 make available a braking force. This measure allows the regeneration of the braking energy to be started immediately after a driver's braking request has been detected.

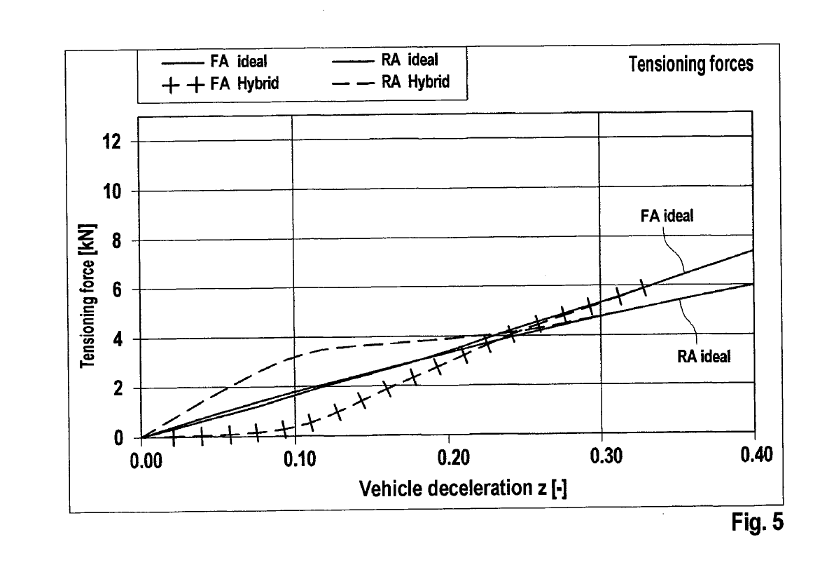

FIG. 5 shows a diagram in which the tensioning forces of the hydraulic wheel brakes 1 at the front axle and the braking force of the rear axle, which is generated by the generator, is represented plotted against the deceleration of the vehicle. The braking force of the generator is represented by + symbols, while the tensioning forces of the front axle wheel brakes are represented by dashes. It is apparent here that the rear axle almost exclusively provides the deceleration up to 0.1 g.

The proposed operator control strategy improves the potential for energy recovery in combined braking systems in hybrid vehicles and virtually the full potential can therefore be utilized with rear axle drive, in a way which is otherwise possible only with special braking systems of the brake-by-wire type. Compared to these braking systems, an optimum braking force distribution can also be set in the case of relatively high deceleration requirements without valve circuits being necessary.

While preferred embodiments of the invention have been described herein, it will be understood that such embodiments are provided by way of example only. Numerous variations, changes and substitutions will occur to those skilled in the art without departing from the spirit of the invention. It is intended that the appended claims cover all such variations as fall within the spirit and scope of the invention.

1.-8. (canceled)

9. A method for operating a combined vehicle braking system comprising hydraulically actuable wheel brakes on a front axle of a motor vehicle and electromechanically actuable wheel brakes on a rear axle of the motor vehicle, said method comprising the steps of:
driving the vehicle wheels which are assigned to the rear axle at least intermittently by an electric motor which is configured to be operated as a generator in order to recover braking energy, wherein in the generator mode a braking force is brought about at the vehicle wheels which are assigned to the rear axle;
detecting a driver's braking request;
communicating the driver's braking request to a control unit which is configured to implement a braking force distribution for the hydraulically actuable wheel brakes on the front axle, the electromechanically actuable wheel brakes on the rear axle and the electric motor; and
implementing the braking force distribution in a range of low vehicle deceleration such that a proportion of extracted braking force at the vehicle wheels of the rear axle is greater than a proportion of extracted braking force at the vehicle wheels of the front axle.

10. The method as claimed in claim 9, wherein the proportion of extracted braking force at the vehicle wheels of the rear axle is generated exclusively or virtually exclusively by the electric motor which is operating in the generator mode.

11. The method as claimed in claim 9, wherein the extracted braking force at the hydraulic wheel brakes is between about 0% and about 49% of a total braking force for the motor vehicle, while the braking force which is generated by the electric motor which is operating in the generator mode is between about 51% and about 100% of the total braking force for the motor vehicle.

12. The method as claimed in claim 9, wherein the braking force distribution is implemented in the range of relatively high vehicle deceleration such that the proportion of extracted braking force at the vehicle wheels of the rear axle is substantially equal to the proportion of extracted braking force at the vehicle wheels of the front axle.

13. The method as claimed in claim 12, wherein the range of low vehicle deceleration is implemented below a vehicle deceleration of about 0.3 g, while the range of relatively high vehicle deceleration is above a vehicle deceleration of about 0.3 g.

14. The method as claimed in claim 9, wherein the control unit carries out the braking force distribution in the range of relatively high vehicle deceleration such that the proportion of extracted braking force at the vehicle wheels of the rear axle is less than the proportion of extracted braking force at the vehicle wheels of the front axle.

15. The method as claimed in claim 14, wherein the range of low vehicle deceleration is implemented below a vehicle deceleration of about 0.3 g, while the range of relatively high vehicle deceleration is above a vehicle deceleration of about 0.3 g.

16. The method as claimed in claim 9, wherein the step of determining the driver's braking request is carried out using a pedal travel sensor that is configured to determine the actuation travel of the brake pedal.

17. The method as claimed in claim 9 further comprising the step of operating the electric motor in the generator mode after detecting the driver's braking request.

18. The method as claimed in claim 17, wherein the step of operating the electric motor in the generator mode is carried out before the step of actuating the hydraulically actuable wheel brakes to produce a braking force.

19. The method as claimed in claim 9, wherein the control unit is an open-loop and closed-loop control unit.
